(19) United States
(12) Patent Application Publication
(10) Pub. No.: US 2014/0098573 A1
(43) Pub. Date: Apr. 10, 2014

(54) DC/DC CONVERTER

(71) Applicant: NATIONAL TSING HUA UNIVERSITY, Hsinchu (TW)

(72) Inventors: Ching-Tsai PAN, Hsinchu (TW); Po-Yen CHEN, Taipei City (TW); Ming-Chieh CHENG, Taipei (TW)

(73) Assignee: NATIONAL TSING HUA UNIVERSITY, Hsinchu (TW)

(21) Appl. No.: 13/689,188

(22) Filed: Nov. 29, 2012

(30) Foreign Application Priority Data
Oct. 5, 2012 (TW) 101136966

(51) Int. Cl. H02M 3/335; H02M 3/158

(52) U.S. Cl. CPC H02M 3/335; H02M 3/158
USPC 363/16; 323/311

(57) ABSTRACT

A DC/DC converter is coupled between a DC source and a load. The DC/DC converter includes a first charge pump circuit coupled to the DC source, a second charge pump coupled to the load, a first switch coupled to the first charge pump circuit, a second switch coupled to the second charge pump circuit, and a first inductor, wherein, one terminal of the first inductor coupled to the first charge pump circuit and the second charge pump circuit, and the other terminal coupled to a common node between the first switch and the second switch. And wherein, the first inductor, the first switch and the second switch are configured between the first charge pump and the second charge pump.

### TECHNICAL FIELD

The present invention relates to a conversion circuit, more especially a bi-directional BuckBoost converter.

### BACKGROUND

FIG. 1A illustrates a conventional schematic of a Boost converter 10. The Boost converter 10 includes two switches 16 and 18, an inductor 14 for energy storage, and a capacitor 17. When the switch 16 is turned on and the switch 18 is turned off, a voltage source 12 charges the inductor 14 and the capacitor 17 provides energy to a load 19. When the switch 16 is turned off and the switch 18 is turned on, the inductor 14 charges the capacitor 17 via the switch 18 and provides energy to the load 19 simultaneously.

FIG. 1B illustrates a conventional schematic of a Buck converter 10′. The Buck converter 10′ is formed when the load 19 and the switch 17 swap the location with the voltage source 12. When the switch 16 is turned off and the switch 18 is turned on, the voltage source 12 charges the inductor 14 and the capacitor 17, and provides energy to the load 19 simultaneously. When the switch 16 is turned on and the switch 18 is turned off, the inductor 14 charges the capacitor 17 via the switch 16 and provides energy to the load 19 simultaneously. According to the description of FIG. 1A and FIG. 1B, the converters shown in FIG. 1A and FIG. 1B are the bi-directional converters.

FIG.2 illustrates a conventional schematic of a bi-directional Buck-Boost converter 20. The Boost converter 29 includes switches 24˜27, an inductor 28, and a capacitor 23. When the switch 24 and the switch 27 are turned on, the switch 25 and the switch 26 are turned off, a voltage source 22 charges the inductor 28 and the capacitor 23 provides energy to a load 21. When the switch 24 and the switch 27 are turned off, the switch 25 and the switch 26 are turned on, the inductor 28 charges the capacitor 23 via the switch 25 and the switch 26, and provides energy to the load 21 simultaneously.

When the load 21 and the capacitor 23 change the location of the voltage source 22, and when the switch 24 and the switch 27 are turned off, the switch 25 and the switch 26 are turned on, the voltage source 22 charges the inductor 28 and the capacitor 23 and provides energy to the load 21. When the switch 24 and the switch 27 are turned on, the switch 25 and the switch 26 are turned off, the inductor 28 charges the capacitor 23 via the switch 24 and provides energy to the load 21 simultaneously. According to the above mentioned, the Boost converter 20 is the dual-direction BuckBoost converter.

According to the description of FIG. 1A, FIG. 1B, and FIG. 2, the function of the inductor (such as the inductor 14 of FIG. 1A and FIG. 1B, and the inductor 28 of FIG. 2) is to transmit the energy. And the function of the capacitor (such as the capacitor 17 of FIG. 1A and FIG. 1B, and the capacitor 23 of FIG. 2) is to filter the output voltage Vo.

In general, the conventional bi-directional Boost converter can be implemented by DC/DC converter which has the synchronous rectification topology, but only one-way Boost or one-way Buck. Although the BuckBoost converter with bi-directional can be implemented by the BuckBoost converter which has the synchronous rectification topology, however, it requires more active components and the ripple of the output voltage is relatively large. It may need the filter elements which has the larger inductance or the capacitance.

Due to the inductance of the inductor of the BuckBoost converter may impacts the response time of the input current and also impacts the ripple of the output voltage, thus, the response time of the input current of the BuckBoost converter is faster when the inductance of the inductor is smaller. Otherwise, the response time of the input current of the BuckBoost converter is slower but the ripple of the output voltage is less.

Thus, the traditional BuckBoost converter usually uses the inductor which has smaller inductance and the output capacitor which has larger capacitance, so as to achieve the goal of fast response time of the input current and less ripple of the output voltage. However, the traditional BuckBoost converter has to use electrolytic capacitors in order to get the larger capacitance. And, electrolytic capacitors are susceptible impacted by the external environmental factors, such as ripple caused by switching and temperature issue, so as to making its short-lived, and further to shorten the live time of the converter.

### SUMMARY

One of the purposes of the invention is to disclose a DC/DC converter coupled between a DC source and a load. The DC/DC converter includes a first charge pump circuit which coupled to the DC source, a second charge pump which coupled to the load, a first switch coupled to the first charge pump circuit, a second switch coupled to the second charge pump circuit, and a first inductor, wherein, one terminal of the first inductor coupled to the first charge pump circuit and the second charge pump circuit, and the other terminal coupled to a common node between the first switch and the second switch. And wherein, the first inductor, the first switch and the second switch are configured between the first charge pump and the second charge pump.

The present invention provides a DC/DC converter which doesn't need to use electrolytic capacitors so as can lengthen the live time of the converter. In addition, the present invention can achieve the advantage of the energy transmission with bi-directional, soft switching, low ripple of the output voltage, and long life time by implementing the charge pump circuit and the semi-resonant circuit.

### BRIEF DESCRIPTION OF THE DRAWINGS

Features and advantages of embodiments of the subject matter will become apparent as the following detailed description proceeds, and upon reference to the drawings, wherein like numerals depict like parts, and in which:

FIG. 1A illustrates a conventional schematic of a Boost converter.

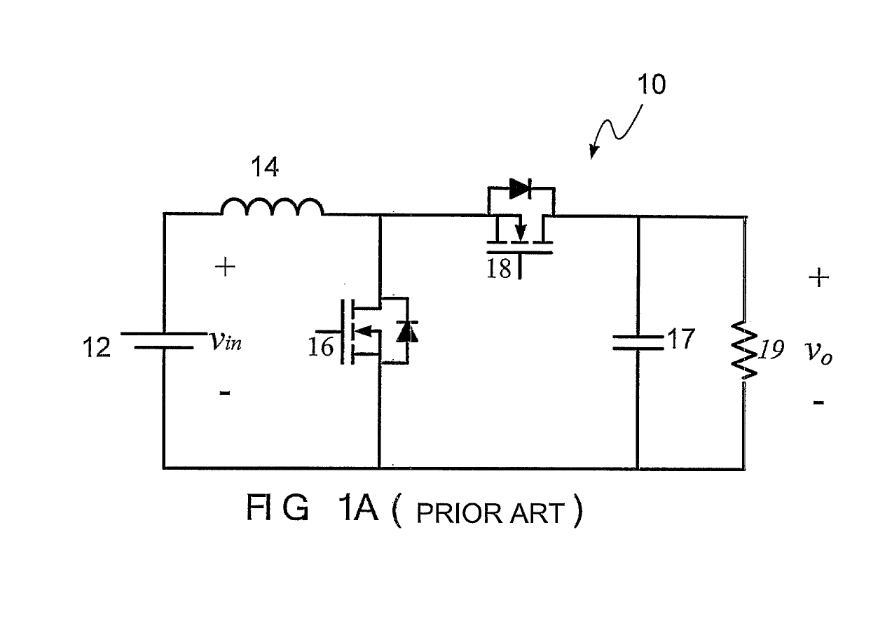

FIG. 1B illustrates a conventional schematic of a Buck converter.

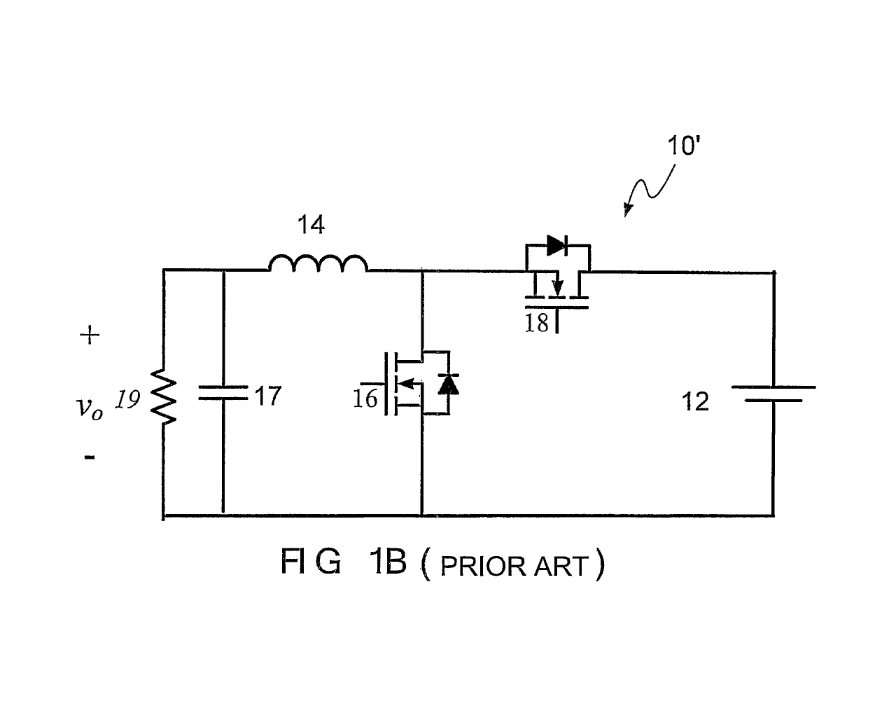

FIG. 2 illustrates a conventional schematic of a bi-directional Buck-Boost converter.

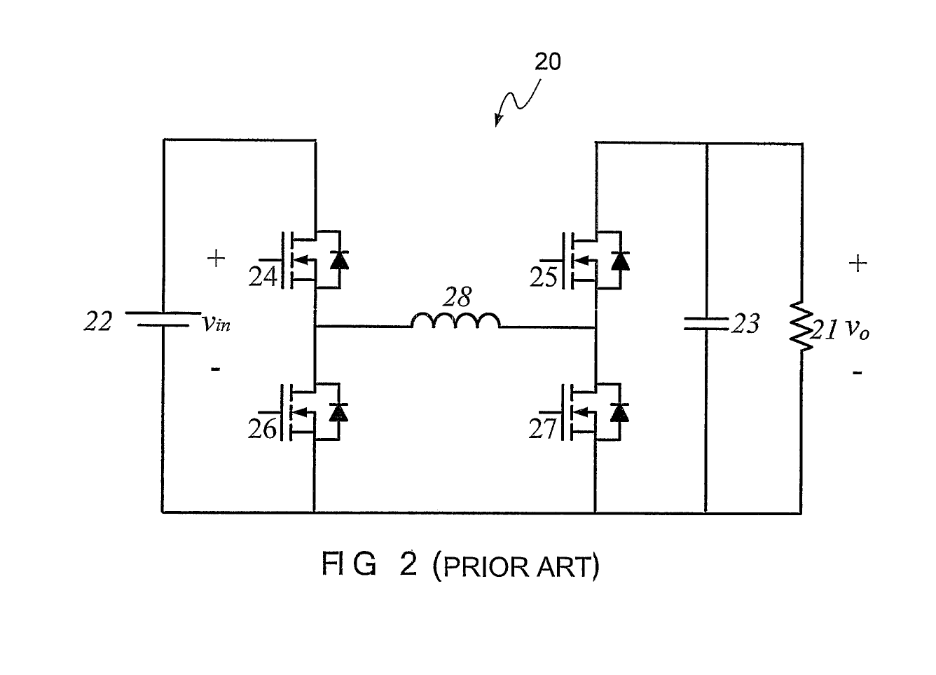

FIG. 3 illustrates a schematic of a bi-directional Buck-Boost converter in accordance with one embodiment of the present invention.

FIG. 4A illustrates an equivalent schematic of the converter of FIG. 3 in the first mode in accordance with one embodiment of the present invention.

FIG. 4B illustrates an equivalent schematic of the converter of FIG. 3 in the second mode in accordance with one embodiment of the present invention.

FIG. 4C illustrates an equivalent schematic of the converter of FIG. 3 in the third mode in accordance with one embodiment of the present invention.

FIG. 4D illustrates an equivalent schematic of the converter of FIG. 3 in the fourth mode in accordance with one embodiment of the present invention.

FIG. 4E illustrates an equivalent schematic of the converter of FIG. 3 in the fifth mode in accordance with one embodiment of the present invention.

FIG. 4F illustrates an equivalent schematic of the converter of FIG. 3 in the sixth mode in accordance with one embodiment of the present invention.

FIG. 5 illustrates a schematic of a bi-directional Buck-Boost converter in accordance with another embodiment of the present invention.

FIG. 5A illustrates an equivalent schematic of the converter of FIG. 5 in the first mode in accordance with one embodiment of the present invention.

FIG. 5B illustrates an equivalent schematic of the converter of FIG. 5 in the second mode in accordance with one embodiment of the present invention.

FIG. 5C illustrates an equivalent schematic of the converter of FIG. 5 in the third mode in accordance with one embodiment of the present invention.

FIG. 5D illustrates an equivalent schematic of the converter of FIG. 5 in the fourth mode in accordance with one embodiment of the present invention.

FIG. 5E illustrates an equivalent schematic of the converter of FIG. 5 in the fifth mode in accordance with one embodiment of the present invention.

FIG. 5F illustrates an equivalent schematic of the converter of FIG. 5 in the sixth mode in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The word “couple” we used in this specification means directly/indirectly connection. In other words, a first apparatus couples to a second apparatus indicates that the first apparatus can directly connect to the second apparatus by electrically connection, wireless connection, or optical connection, but not limited to. Or, the first apparatus can electrically or signally connect to the second apparatus via any other device or connection means indirectly.

The description of the “and/or” in this specification includes one of the listed objects or any combination of the multiple objects. In addition, unless specifically stated by this specification, otherwise, the usage of any singular terms in this specification includes the meaning of plural also.

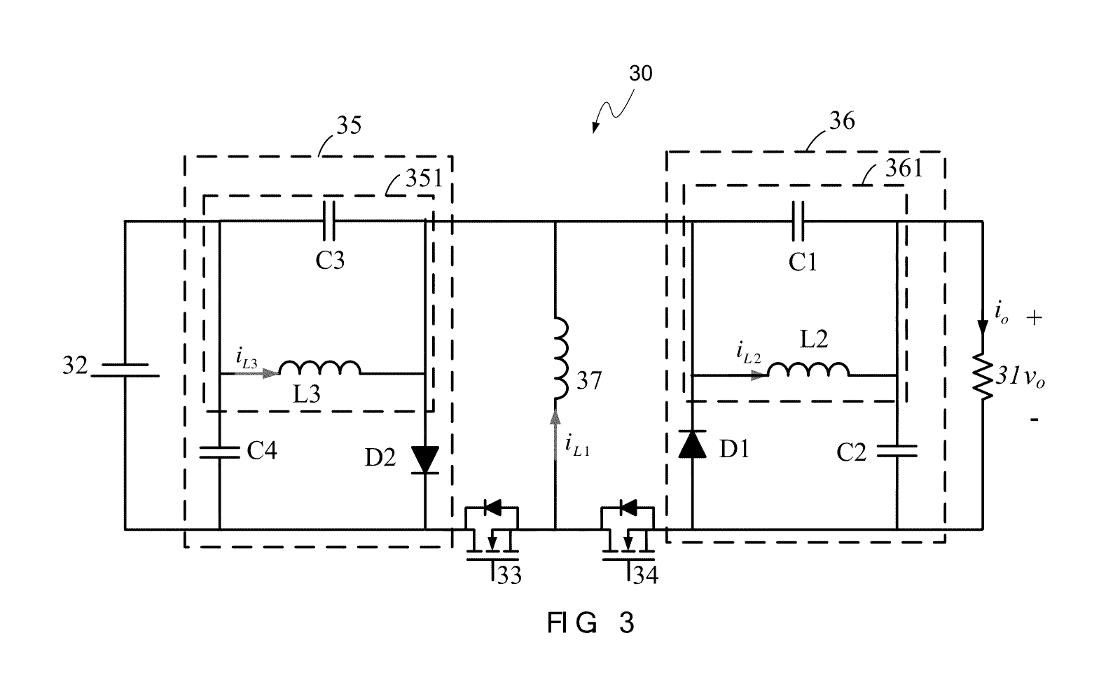

FIG. 3 illustrates a schematic of a bi-directional Buck-Boost converter 30 in accordance with one embodiment of the present invention. The converter 30 includes switches 33 and 34, a first charge pump circuit 35, a second charge pump circuit 36, and an inductor 37. In one embodiment, the first charge pump circuit 35 includes a first semi-resonant circuit 351, a capacitor C4 series coupled to the first semi-resonant circuit 351, and a diode D2 series coupled to the first semi-resonant circuit 351 then parallel coupled to the capacitor C4. In one embodiment, the first semi-resonant circuit 351 is composed by an inductor L3 and a capacitor C3 parallel coupled with the inductor L3. Wherein, the first semi-resonant circuit 351 is series coupled to the capacitor C4 in order to divide the voltage. In one embodiment, the second charge pump circuit 36 includes a second semi-resonant circuit 361, a capacitor C2 series coupled to the second semi-resonant circuit 361, and a diode D1 series coupled to the second semi-resonant circuit 361 then parallel coupled to the capacitor C2. In one embodiment, the second semi-resonant circuit 361 is composed by an inductor L2 and a capacitor C1 parallel coupled with the inductor L2. Wherein, the second semi-resonant circuit 361 is series coupled to the capacitor C2 in order to divide the voltage. In one embodiment, the inductor 37, the switch 33 and the switch 34 are coupled between the first charge pump circuit 35 and the second charge pump circuit 36. One end of the inductor 37 is coupled to the capacitor C3 and the capacitor C1, and the other end of the inductor 37 is coupled to a common node between the switch 33 and the switch 34. Wherein, the switch 33 and the switch 34 are coupled to the first charge pump circuit 35 and the second charge pump circuit 36 respectively.

Shown in FIG. 3, when the switch 33 and the switch 34 are turned off, the energy stored in the first semi-resonant circuit 351 turns on the body diode of the switch 33 via the inductor 37 and the capacitor 34. Thus, the switch 33 is turned on and the soft switching is finished. When the switch 33 is turned on, the voltage source 32 charges the first semi-resonant circuit 351, the inductor 37, and the capacitor C4. At this moment, the capacitance of the capacitor C4 of the first charge pump circuit 35 is larger than the capacitance of the capacitor C3. Thus, the energy comes from the voltage source 32 is stored in the first semi-resonant circuit 351 to force the cross voltage of the capacitor C3 increases rapidly. Then, the polarity of the cross voltage of the capacitor C3 is reversed due to the function of the LC resonant circuit, so as to prepare the soft switching of the switch 33. Meanwhile, the cross voltage of the capacitor C1 keeps in negative, so as to turn on the diode D1 and achieve the goal of the energy balance of the circuit and keeps the circuit operates. And, the energy is transferred to the capacitor C2 and the load 31 via the diode D1 so as to prepare the soft switching of the switch 34.

When the switches 33 and 34 are turned off again, the energy stored in the second semi-resonant circuit 361 turns on the body diode of the switch 34 via the inductor 37 and the capacitor C4. Thus, the switch 34 is turned on and the soft switching is finished. When the switch 34 is turned on, the inductor 37 charges the second semi-resonant circuit 361 and the capacitor C2 via the switch 34 and transfers the energy to the load 31. At this moment, the capacitance of the capacitor C2 of the first charge pump circuit 36 is larger than the capacitance of the capacitor C1. Thus, the energy comes from the voltage source 32 is stored in the second semi-resonant circuit 361 to force the cross voltage of the capacitor C1 increases rapidly. Then, the polarity of the cross voltage of the capacitor C1 is reversed due to the function of the LC resonant circuit, so as to prepare the soft switching of the switch 34. Meanwhile, the cross voltage of the capacitor C3 keeps in negative, so as to turn on the diode D2 and achieve the goal of the energy balance of the circuit and keeps the circuit operates. And, the energy is transferred to the capacitor C4 and the load 31 via the diode D2 so as to prepare the soft switching of the switch 33.

In one embodiment, the first charge pump circuit 35 and the second charge pump 36 are auto charge pumps with voltage type. In one embodiment, the output voltage Vo on the load 31 which outputted from the converter 30 is corresponding adjustable by modulating the conducting times of the switches 33 and 34. In another embodiment, the output voltage Vo on the load 31 which outputted from the converter 30 is corresponding adjustable by modulating the switching frequencies of the switches 33 and 34.

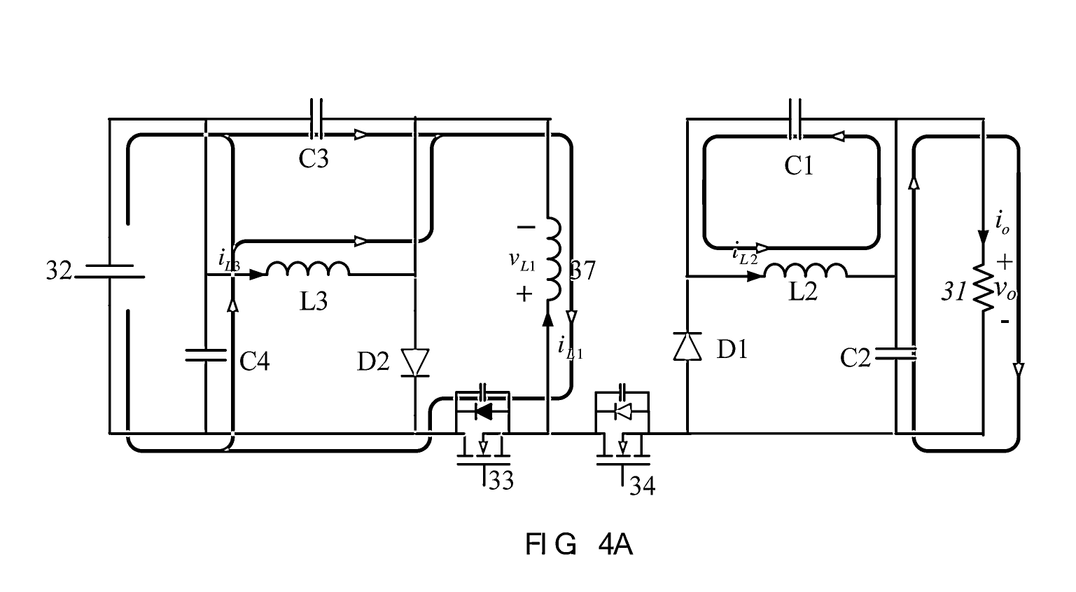

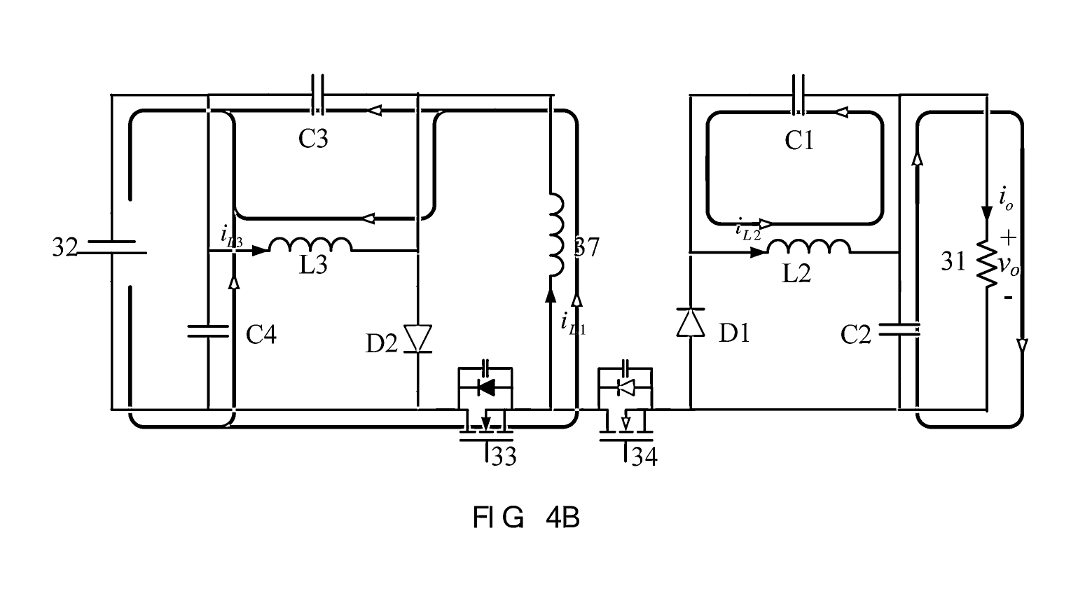

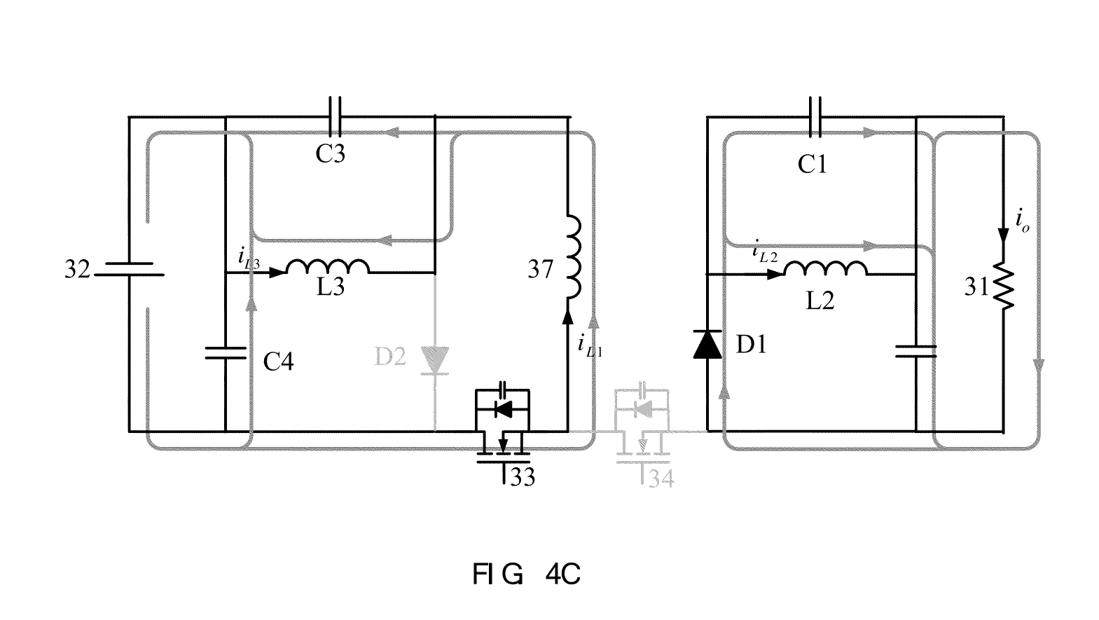

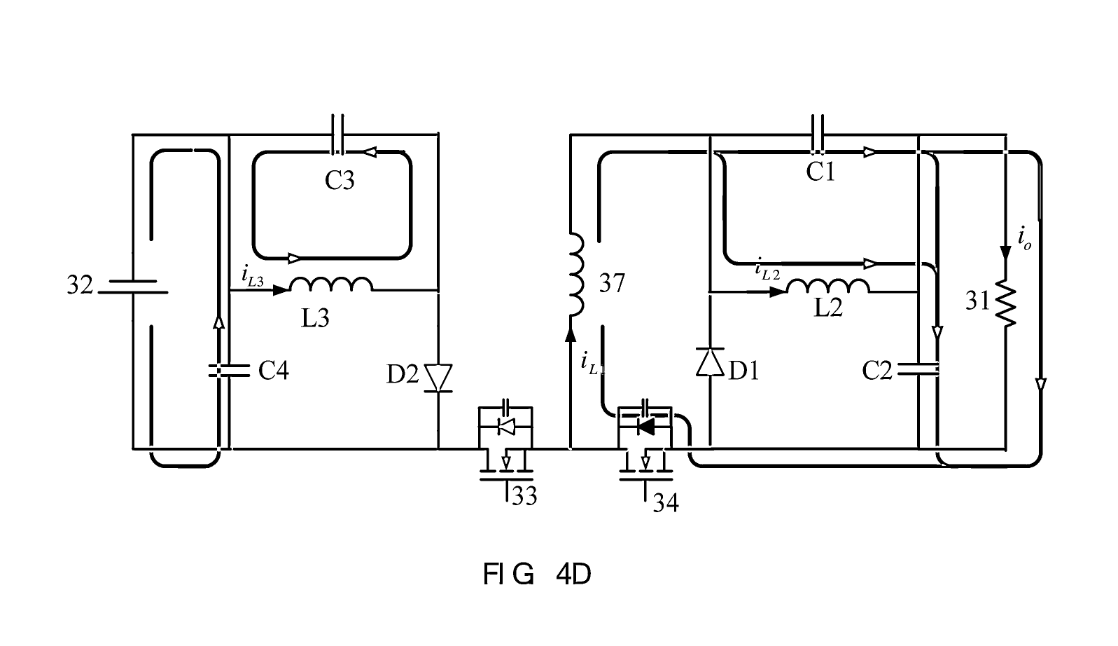

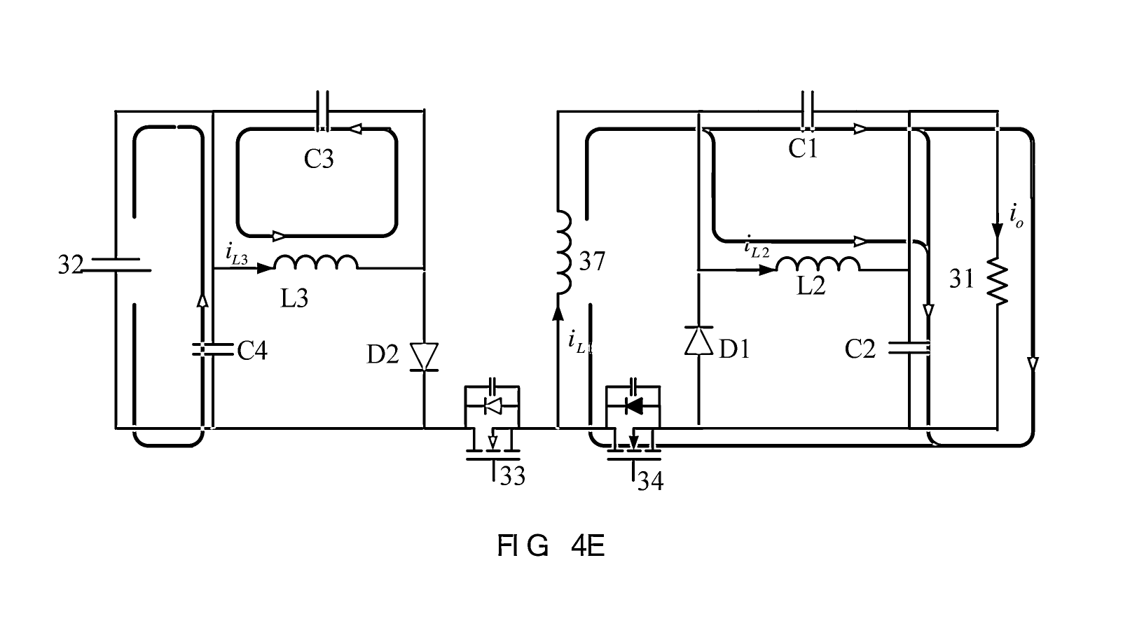

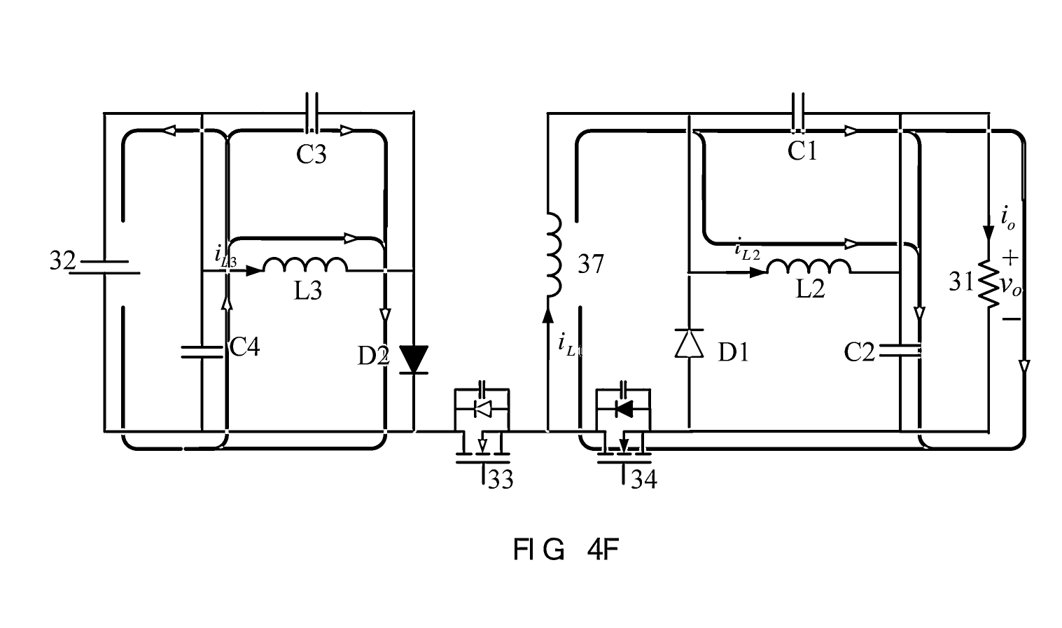

FIG. 4A to FIG. 4F illustrate equivalent schematics of the converter 30 of FIG. 3 in the first mode to the sixth mode in accordance with one embodiment of the present invention. Elements labeled the same as in FIG. 3 have similar functions, and FIG. 4A to FIG. 4F are described in combination with FIG. 3. For clearly illustration, all elements of the circuit are assumed as ideal components. In the embodiment, the inductor 37 and L₂ are operating in a continuous current mode. The voltage of the capacitor C2 is kept in a constant value. Meanwhile, in one embodiment, the load 31 is a resistor.

FIG. 4A illustrates an equivalent schematic of the converter 30 of FIG. 3 in the first mode in accordance with one embodiment of the present invention. When the body diode of the switch 33 is turned on and the switch 34 is turned off, the polarity of the cross voltage of the capacitor C3 is negative, so as to prepare the soft switching of the switch 33 via the inductor 37. The voltage source 32 charges the capacitor C4, and the inductor L2 is resonating with the capacitor C1 to convert the stored energy of the capacitor C1 to an inductor current i_{L2}. Meanwhile, the capacitor C2 provides energy to the load 31.

FIG. 4B illustrates an equivalent schematic of the converter 30 of FIG. 3 in the second mode in accordance with one embodiment of the present invention. The converter 30 enters a second mode when the switch 33 is turned on and the switch 34 is turned off. When the switch 33 is turned on and the switch 34 is turned off, the switch 33 finishes the soft switching, and the voltage source 32 charges the inductor 37 and the first semi-resonant circuit 351 via the switch 33. The second semi-resonant circuit 361 keeps resonating to covert the stored energy of the capacitor C1 to the inductor current i_{L2}, and the capacitor C2 provides energy to the load 31.

FIG. 4C illustrates an equivalent schematic of the converter 30 of FIG. 3 in the third mode in accordance with one embodiment of the present invention. The converter 30 enters a third mode when the diode D1 is turned on. In the third mode, the voltage source 32 keeps charging the inductor 37 and the first semi-resonant circuit 351 via the switch 33. Also, the second semi-resonant circuit 361 keeps resonating to covert the stored energy of the capacitor C1 to the inductor current i_{L2}, and the second semi-resonant circuit 361 reverses the polarity of the cross voltage of the capacitor C1 in order to turn on the diode D1 and changes the circuit topology. Meanwhile, the capacitor C2 provides energy to the load 31.

FIG. 4D illustrates an equivalent schematic of the converter 30 of FIG. 3 in the fourth mode in accordance with one embodiment of the present invention. The converter 30 enters a fourth mode when the switch 33 is turned off and the body diode of the switch 34 is turned on. In the fourth mode, the polarity of the cross voltage of the capacitor C1 is negative, the current flowing through the inductor 37 flows through the body diode of the switch 34, so as to prepare the soft switching of the switch 34. The voltage source 32 charges the capacitor C4 and the first semi-resonant circuit 351 resonates to convert the stored energy of the capacitor C3 to an inductor current i_{L3}. At the same time, the inductor 37 charges the second semi-resonant circuit 361 and the capacitor C2 and provides energy to the load 31.

FIG. 4E illustrates an equivalent schematic of the converter 30 of FIG. 3 in the fifth mode in accordance with one embodiment of the present invention. The converter 30 enters a fifth mode when the switch 33 is turned off and the switch 34 is turned on. In the fifth mode, the switch 34 finishes the soft switching. The inductor 37 charges the second semi-resonant circuit 361 and the capacitor C2 via the switch 34 and provides energy to the load 31. The first semi-resonant circuit 351 keeps resonating to convert the stored energy of the capacitor C3 to the inductor current

FIG. 4F illustrates an equivalent schematic of the converter 30 of FIG. 3 in the sixth mode in accordance with one embodiment of the present invention. The converter 30 enters a sixth mode when the diode D2 is turned on. In this mode, the inductor 37 charges the second semi-resonant circuit 361 and the capacitor C2 via the switch 34 and provides energy to the load 31. The first semi-resonant circuit 351 keeps resonating to convert the stored energy of the capacitor C1 to the inductor current i_{L3}. And, the first semi-resonant circuit 351 reverses the cross voltage of the capacitor C3 to turn on the diode D2 so as to transfer the energy to the capacitor C4. At this time, the load 41 is provided energy by the capacitor C2. When the body diode of the switch 33 is turned on and the switch 34 is turned off, one cycle of the converter 30 is finished.

According to the bi-directional BuckBoost converter 30 of the present invention, the inductor 37 and the inductor L2 are act as energy storages when the switch 33 is turned on and the switch 34 is turned off. The body diode of the switch 33 is turned on due to function of the charge pump circuit and due to the cross voltage of the capacitor C3 is reversed as −Vin when the switch 33 is turned on. Thus, the switch 33 is processing the soft switching. Furthermore, according to the voltage dividing theorem, most of the voltages are crossed on the capacitor C3 due to the capacitance of the capacitor C4 is larger than the capacitance of the capacitor C3, thus, the voltage ripple of the inductor which caused by the input current can be reduced. When the switch 33 is turned off and the switch 34 is turned on, the inductor 37 and the inductor L3 are act as energy storage. The body diode of the switch 34 is turned on due to function of the charge pump circuit and due to the cross voltage of the capacitor C1 is reversed as −Vo when the switch 34 is turned on. Thus, the switch 34 is processing the soft switching. Furthermore, according to the voltage dividing theorem, most of the voltages are crossed on the capacitor C2 due to the capacitance of the capacitor C2 is larger than the capacitance of the capacitor C1, thus, the ripple of the output voltage which caused by the input current can be reduced. The capacitor C1 and the inductor L2 change the circuit topology and parallel coupled with the capacitor C2 due to the conductance of the diode D1, thus, the output voltage has lower output ripple and the life time of the converter 30 can be lengthen without using electrolytic capacitors.

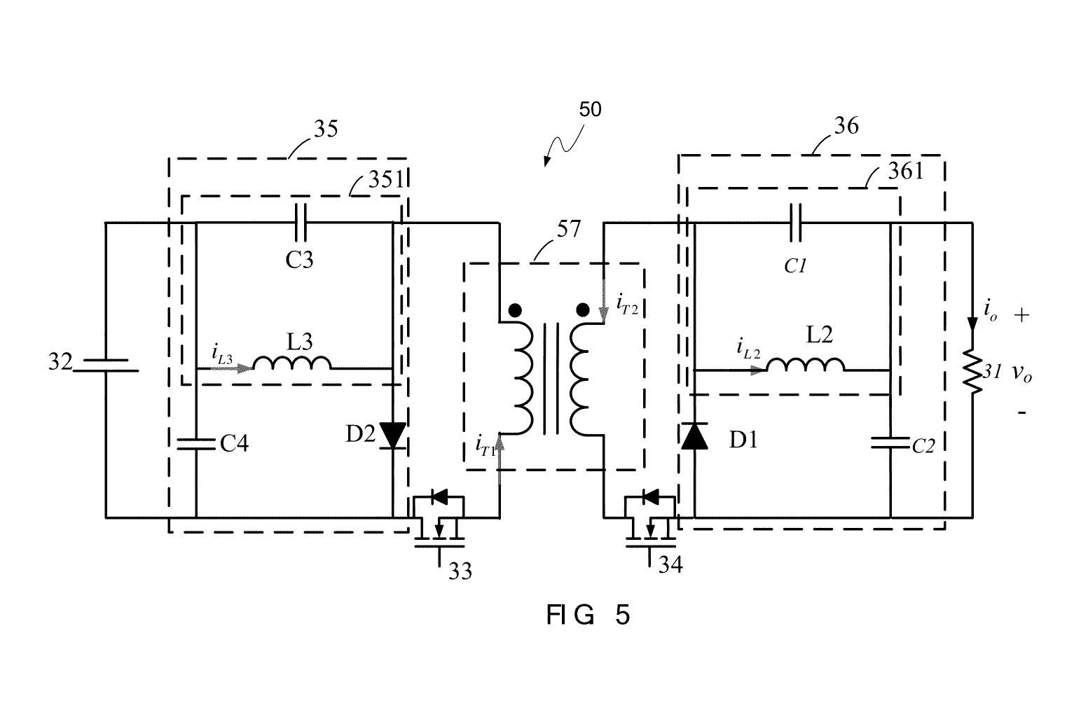

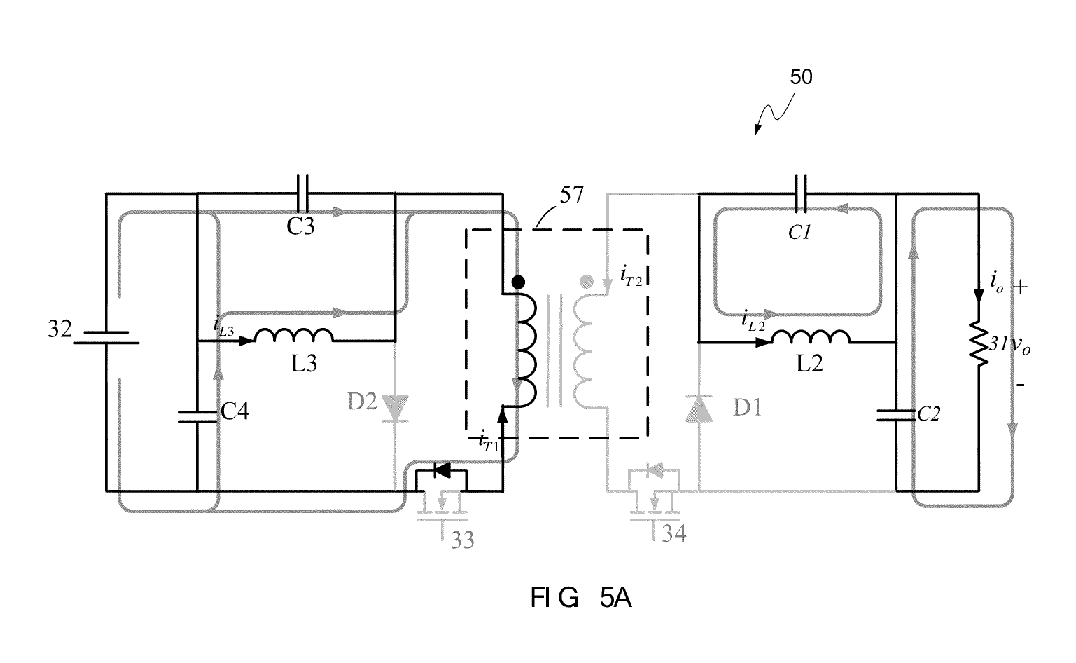

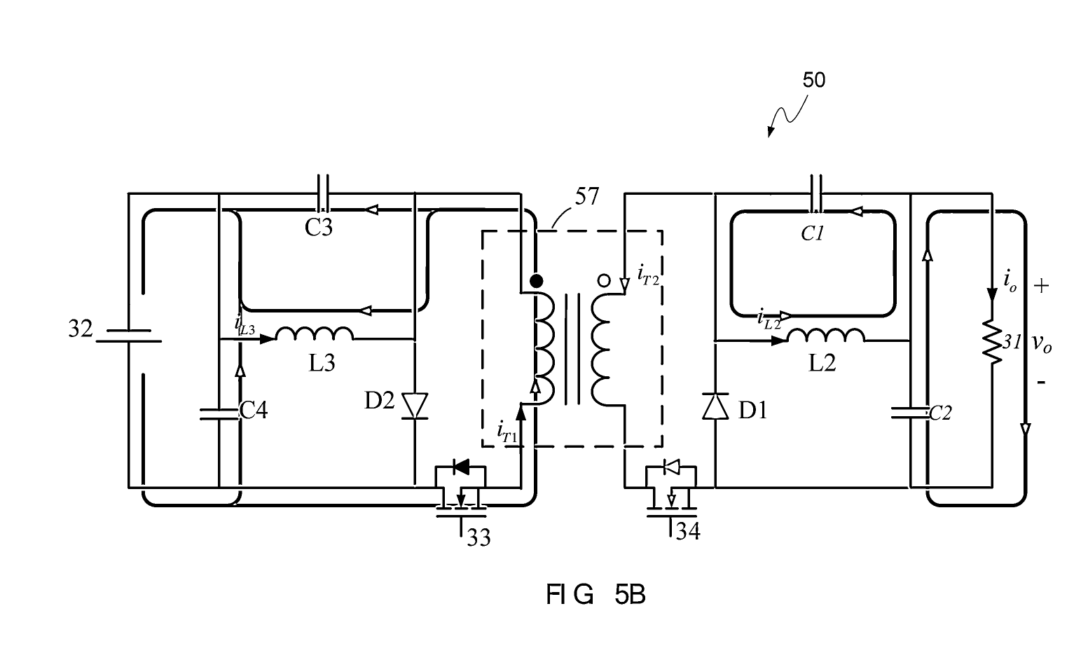

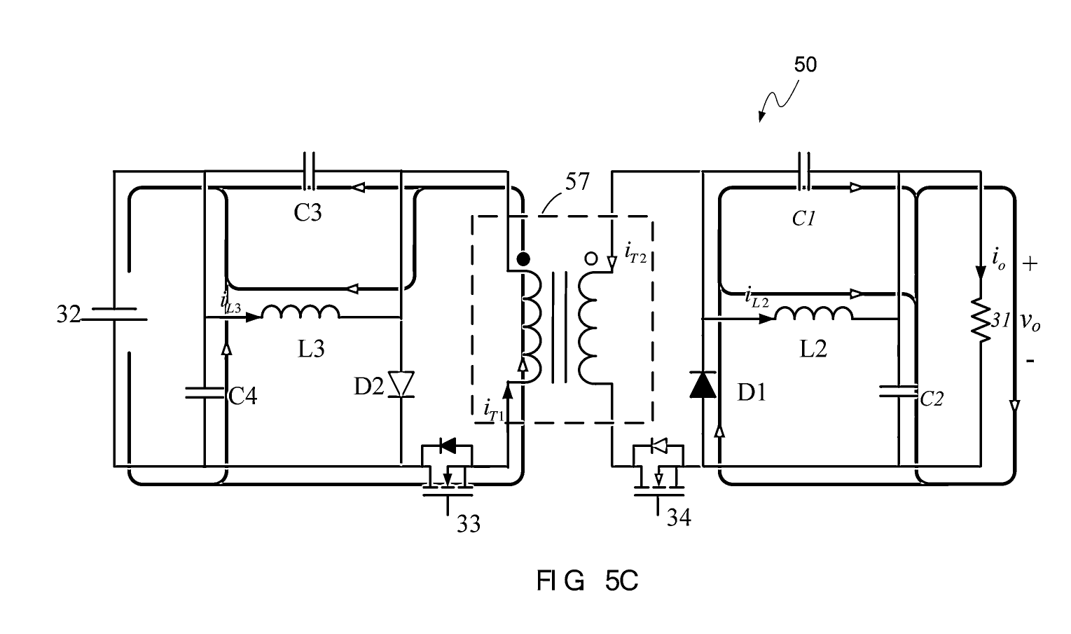

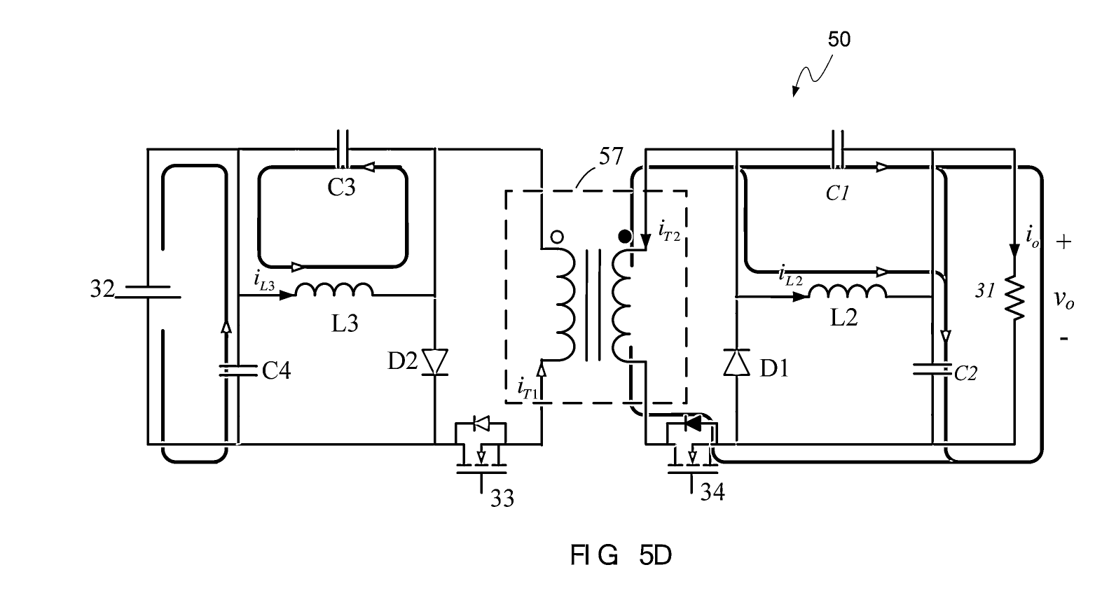

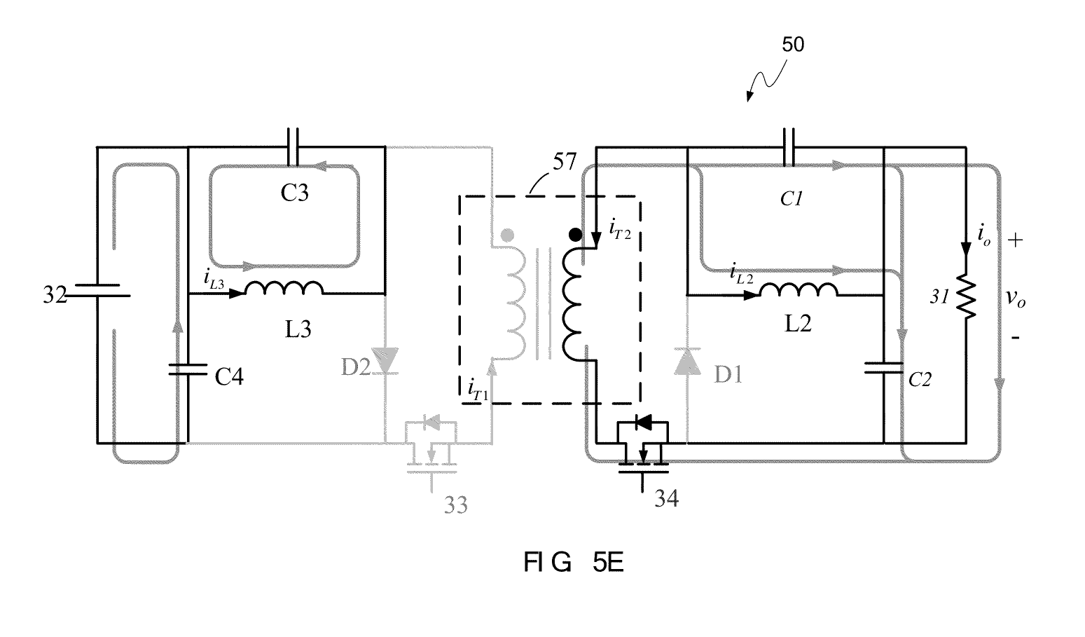

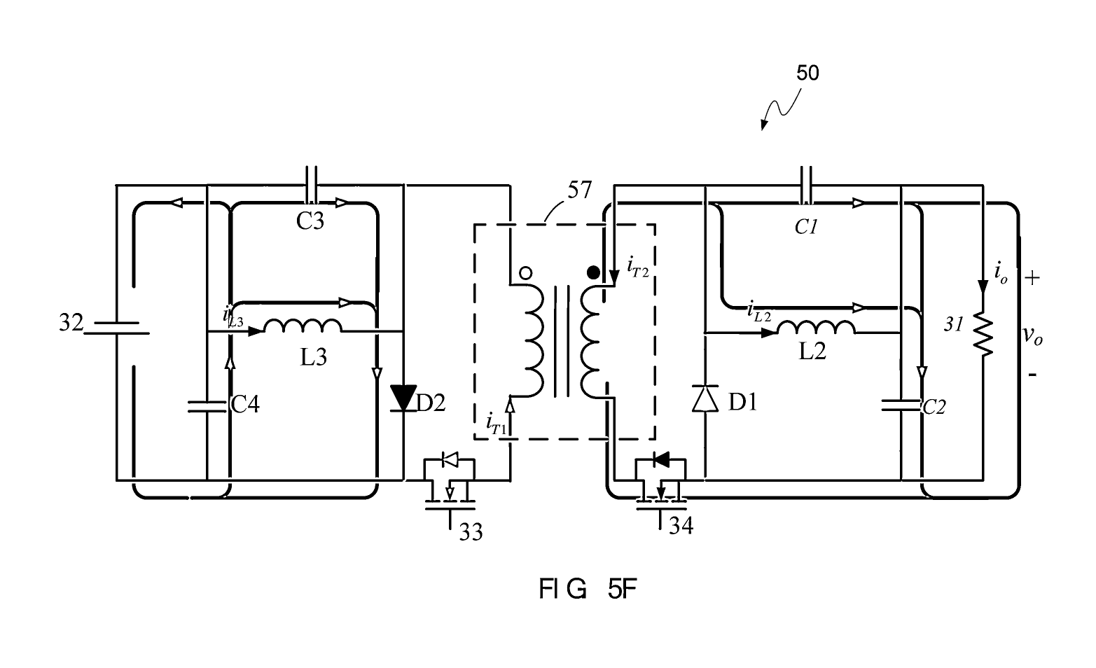

FIG. 5 illustrates a schematic of a bi-directional Buck-Boost converter 50 in accordance with another embodiment of the present invention. Elements labeled the same as in FIG. 3 have similar functions. In this embodiment, a transformer 57 is replacing the inductor 37 which shown in FIG. 3, thus, the converter 50 becomes an isolation DC/DC converter.

The converter 50 includes switches 33 and 34, a first charge pump circuit 35, the second charge pump circuit 36, and a transformer 57. In one embodiment, the first charge pump circuit 35 includes a first semi-resonant circuit 351, a capacitor C4 series coupled to the first semi-resonant circuit 351, and a diode D2 series coupled to the first semi-resonant circuit 351 then parallel coupled to the capacitor C4. In one embodiment, the first semi-resonant circuit 351 is composed by an inductor L3 and a capacitor C3 parallel coupled with the inductor L3. Wherein, the first semi-resonant circuit 351 is series coupled to the capacitor C4 in order to divide the voltage. In one embodiment, the second charge pump circuit 36 includes a second semi-resonant circuit 361, a capacitor C2 series coupled to the second semi-resonant circuit 361, and a diode D1 series coupled to the second semi-resonant circuit 361 then parallel coupled to the capacitor C2. In one embodiment, the second semi-resonant circuit 361 is composed by an inductor L2 and a capacitor C1 parallel coupled with the inductor L2. Wherein, the second semi-resonant circuit 361 is series coupled to the capacitor C2 in order to divide the voltage.

In one embodiment, one end of the primary winding of the transformer 57 is series coupled to the switch 33, and the other end of the primary winding of the transformer 57 is coupled to the capacitor C3. One end of the secondary winding of the transformer 57 is series coupled to the switch 34, and the other end of the secondary winding of the transformer 57 is coupled to the capacitor C1. Wherein, the switches 33 and 34 are coupled to the first charge pump circuit 35 and the second charge pump circuit 36 respectively.

FIG. 5A to FIG. 5F illustrate equivalent schematics of the converter 50 of FIG. 5 in the first mode to the sixth mode in accordance with another embodiment of the present invention. Elements labeled the same as in FIG. 5 have similar functions, and FIG. 5A to FIG. 5F are described in combination with FIG. 5. For clearly illustration, all elements of the circuit are assumed as ideal components. In the embodiment, the inductor L₃ and L₂ are operating in a continuous current mode. The voltage of the capacitor C2 is kept in a constant value. Meanwhile, in one embodiment, the load 31 is a resistor.

FIG. 5A illustrates an equivalent schematic of the converter 50 of FIG. 5 in the first mode in accordance with one embodiment of the present invention. When the body diode of the switch 33 is turned on and the switch 34 is turned off, the polarity of the cross voltage of the capacitor C3 is negative, the body diode of the switch 33 is turned on by the transformer 57 so as to prepare the soft switching of the switch 33. The voltage source 32 charges the capacitor C4 and the inductor L2 resonates with the capacitor C1 to convert the stored energy of the capacitor C1 to an inductor current i_{L2}, meanwhile, the capacitor C2 provides energy to the load 31.

FIG. 5B illustrates an equivalent schematic of the converter 50 of FIG. 5 in the second mode in accordance with one embodiment of the present invention. The converter 50 enters a second mode when the switch 33 is turned on and the switch 34 is turned off In the second mode, the switch 33 finishes the soft switching. The voltage source 32 charges the transformer 57 and the first semi-resonant circuit 351 via the switch 33. The second semi-resonant circuit 36a keeps resonating to convert the stored energy of the capacitor C2 to the inductor current i_{L2}, meanwhile, the capacitor C2 keeps providing energy to the load 31.

FIG. 5C illustrates an equivalent schematic of the converter 50 of FIG. 5 in the third mode in accordance with one embodiment of the present invention. The converter 50 enters a third mode when the diode D1 is turned on. In the third mode, the voltage source 32 keeps charging the transformer 57 and the first semi-resonant circuit 351 via the switch 33. And, the second semi-resonant circuit 361 keeps resonating to convert the stored energy to the inductor current and the second semi-resonant circuit 361 reverses the polarity of the cross voltage of the capacitor C1 to turn on the diode, thus, the circuit topology is changed so as to transfer the energy to the capacitor C2 and the load 31.

FIG. 5D illustrates an equivalent schematic of the converter 50 of FIG. 5 in the fourth mode in accordance with one embodiment of the present invention. The converter 50 enters a fourth mode when the switch 33 is turned off and the body diode of the switch 34 is turned on. In the fourth mode, the polarity of the cross voltage of the capacitor C1 is negative, the body diode of the switch 34 is turned on via the transformer 57, so as to prepare the soft switching of the switch 34. The voltage source 32 charges the capacitor C4, the first semi-resonant circuit 351 is resonating to convert the stored energy of the capacitor C3 to an inductor current i_{L3}. Meanwhile, the secondary winding of the transformer 57 charges the inductor L2, the capacitor C1 and the capacitor C2 and also provides energy to the load 31.

FIG. 5E illustrates an equivalent schematic of the converter 50 of FIG. 5 in the fifth mode in accordance with one embodiment of the present invention. The converter 40 enters a fifth mode when the switch 33 is turned off and the switch 34 is turned on. In the fifth mode, the switch 34 finishes the soft switching. The transformer 57 charges the second semi-resonant circuit 361 and the capacitor C2 via the switch 34 and also provides energy to the load 31. The first semi-resonant circuit 35a keeps resonating to convert the stored energy of the capacitor C3 to the inductor current i_{L3}.

FIG. 5F illustrates an equivalent schematic of the converter 50 of FIG. 5 in the sixth mode in accordance with one embodiment of the present invention. The converter 50 enters a sixth mode when the diode D2 is turned on. In the sixth mode, the transformer 57 charges the second semi-resonant circuit 361 and the capacitor C2 via the switch 34 and also provides energy to the load 31. The first semi-resonant circuit 351 keeps resonating to convert the stored energy of the capacitor C1 to the inductor iL3 and the first semi-resonant circuit 351 reverses the polarity of the cross voltage of the capacitor C3 to turn on the diode D2 so as to change the circuit topology and transfers energy to the load 31. At this moment, the energy of the load 31 is provided only by the capacitor C2. When the body diode of the switch 33 is turned on and the switch 34 is turned off, one cycle of the converter 50 is finished.

The present invention provides a DC/DC converter with back-to-back symmetric architecture, it can execute the energy transmission in opposite direction by swapping the location of the load and the voltage source. In conclusion, the bi-directional DC/DC converter of the present invention can avoid the capacitor saturation of the semi-resonant circuit and the circuit structure is adjustable to achieve the goals of the energy transmission in bi-directional, soft switching, low ripple of the output voltage and long life time by designing the circuit parameters and by the function of the LC resonant circuits.

While the foregoing description and drawings represent embodiments of the present invention, it will be understood that various additions, modifications and substitutions may be made therein without departing from the spirit and scope of the principles of the present invention. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, and not limited to the foregoing description.

What is claimed is:

1. A DC-DC converter coupled between a DC source and a load, comprising:
a first charge pump circuit coupled to said DC source;
a second charge pump circuit coupled to said load;
a first switch coupled to said first charge pump circuit;
a second switch coupled to said second charge pump circuit; and
a first inductor, wherein one terminal of aid first inductor coupled to said first charge pump circuit and said second charge pump circuit, and the other terminal coupled to a common node between said first switch and said second switch;
wherein, said first inductor, said first switch and said second switch are configured between said first charge pump circuit and said second charge pump circuit.

2. The converter as claimed in claim 1, wherein said first charge pump circuit comprises:
a first semi-resonant circuit includes a first capacitor and a second inductor coupled in parallel; and
a first diode and a second capacitor series coupled to said first semi-resonant circuit.

3. The converter as claimed in claim 1, wherein said second charge pump circuit comprises:
a second semi-resonant circuit includes a third capacitor and a third inductor coupled in parallel; and
a second diode and a fourth capacitor series coupled to said second semi-resonant circuit.

4. The converter as claimed in claim 1, wherein said first switch and said second switch are power transistors.

5. The converter as claimed in claim 1, wherein said first charge pump circuit and said second charge pump circuit are auto charge pump circuits with voltage type, and said first charge pump circuit and said second charge pump circuit are configured as back-to-back.

6. A DC-DC converter coupled between a DC source and a load, comprising:
a first charge pump circuit coupled to said DC source;
a second charge pump circuit coupled to said load;
a transformer, a primary winding of said transformer series coupled to a first switch and a secondary winding of said transformer series coupled to a second switch, wherein, said primary winding and said first switch parallel coupled to said first charge pump circuit, and said secondary winding and said second switch parallel coupled to said second charge pump circuit.

7. The converter as claimed in claim 6, wherein said first charge pump circuit comprises:
a first semi-resonant circuit includes a first capacitor and a first inductor coupled in parallel; and
a first diode and a second capacitor series coupled to said first semi-resonant circuit.

8. The converter as claimed in claim 6, wherein said second charge pump circuit comprises:
a second semi-resonant circuit includes a third capacitor and a second inductor coupled in parallel; and
a second diode and a fourth capacitor series coupled to said second semi-resonant circuit.

9. The converter as claimed in claim 6, wherein said first switch and said second switch are power transistors.

10. The converter as claimed in claim 6, wherein said first charge pump circuit and said second charge pump circuit are auto charge pump circuits with voltage type, and said first charge pump circuit and said second charge pump circuit are configured as back-to-back.

11. The converter as claimed in claim 6, wherein said transformer is a flyback transformer.
